(19) United States
(12) Patent Application Publication
(10) Pub. No.: US 2003/0110026 A1
(43) Pub. Date: Jun. 12, 2003

(54) Systems and methods for communicating through computer animated images

(76) Inventor: Minoru Yamamoto, Yokohama-shi (JP)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/320,149

(22) Filed: Dec. 16, 2002

Related U.S. Application Data
(63) Continuation-in-part of application No. 09/218,569, filed on Dec. 22, 1998.
Application No. 09/218,569 is a division of application No. 08/636,874, filed on Apr. 23, 1996, now Pat. No. 5,923,337.

(51) Int. Cl. G10L 13/06; G10L 11/04; G10L 21/00

(52) U.S. Cl. 704/207; 704/266; 704/270; 704/275

(57) ABSTRACT

The current animation sequence is generated for a live character during communication. In response to a performer's voice and other inputs, the animation sequence of the character is generated on a real-time basis and approximates the movements associated with human speech. The animated character is capable of expressing certain predetermined states of mind such as happy, angry and surprised. In addition, the animated character is also capable of approximating natural movements associated with speech.

### RELATED APPLICATION DATA

This application is a Rule 53(b)(2) Continuation-In-Part application of U.S. application Ser. No. 09/218,569 filed on Dec. 22, 1998, which is a continuation of application Ser. No. 08/636,874.

### FIELD OF THE INVENTION

The current invention is generally related to a user-controlled real-time computer animation for communicating with a viewer and is particularly related to a character image animated according to user voice and other inputs.

### BACKGROUND OF THE INVENTION

In the field of computer-graphics, a character has been animated for various purposes. Whether or not the character be a human, an animal or an object, computer scientists and computer-graphics animators have attempted to animate the character as if it is capable of communicating with a viewer. At the infancy of computer graphics, the character generally teaches or entertains the viewer in a non-interactive manner without responding to the viewer. As computer graphics has matured, the character had been animated in a slightly interactive manner. To support such an interaction between the character and the viewer, the character image must be animated on a real-time basis.

Despite significant advances in hardware and software, real-time character animation is still a difficult task. Among various images to be animated, character, human or otherwise, generally requires complex calculations at a high speed for rendering a large number of image frames. In particular, to communicate with a viewer in an interactive manner, the character animation must be able to synchronize its lip movement with an audio output as well as to express complex emotions. To accommodate such complex high-speed calculations, an expensive animation system including a high-performance processor is necessary. In addition, the complex input sub-system for inputting various information such as lip movements, limb movements and facial expressions are also necessary.

In the attempts to solve the above-described problems, the VACTOR™ system, includes a high-performance three-dimensional rendering unit along with a complex input sub-system. An character image is rendered on a real-time basis based upon the inputs generated by a special sensor gear that a performer wears. The special sensor gear includes a position sensor placed around the lips of the performer, and certain exaggerated mouth movements generate desired mouth position signals. The performer also wears another set of position sensors on limbs for signaling certain limb movements. However, it has been reported that these position sensor gears are not ergonomically designed and requires a substantial amount of training to generate desired signals. Furthermore, the cost of the VACTOR™ system is beyond the reach of most commercial enterprises and let alone individual consumers.

On the other hand, certain prior art two-dimensional animation systems do not generally require the above-described complex hardware and software and are usually affordable for the lack of realistic animation. For example, a two-dimensional character image is animated based upon the presence or the absence of a voice input. In this simplistic system, the mouth is animated open and closed during the voice input, and the animation is terminated when there is no more voice input. To animate the mouth, animation frames depicting the open mouth and the closed mouth is stored in an animation database, and upon the receipt of the voice input, an animation generator outputs the above-described animation frames to approximate the mouth movement in a crude manner. In other words, since this system has the same monotonous open and close mouth movement in response to various voice patterns, the animated character image fails to appear interactive. Furthermore, the image character generally fails to produce facial expressions.

As described above, the prior attempts have not yet solved the cost performance problem for a real-time animation system capable of generating a lively character image for communicating with a viewer using generally available personal computers such as IBM-compatible or MacIntosh. A method and a system of generating a real-time yet lively character image on a widely available platform would substantially improve a cost performance relation that the above-described prior attempts had failed.

The animation system satisfying the above-described cost performance relation has a wide variety of application fields. In addition to traditional instructional and entertainment applications, for example, such a character animation system may be used to promote products at trade shows, author a short animation for various uses such as games and broadcasting, as well as to interface an end user. The image character animation may be authored in advance of the use or may be generated in response to a viewer response in an interactive manner.

### SUMMARY OF THE INVENTION

To solve the above and other problems, according to a first aspect of the current invention, a method of analyzing a digitized voice input, including the steps of: digitizing speech into digitize voice input; generating a plurality of waves based upon the digitized voice; selecting a set of first coefficients based upon a pitch level of the speech; pitch shifting the waves according to a corresponding one of the selected first coefficients; selecting a set of second coefficients based upon a speed of the speech; and adding said pitch shifted waves based upon the second coefficients so as to generate a merged wave.

According to a second aspect of the current invention, an input voice analyzing apparatus for analyzing a digitized voice input, for speech including: a wave processing unit for selecting a set of first coefficients based upon a pitch of the speech and generating a plurality of pitch shifted waves based upon the first coefficients, the wave processing unit selecting a set of second coefficients based upon a speed of the speech and adding the pitch shifted waves based upon the second coefficients so as to generate an enhanced wave; and a wave analysis unit connected to the wave processing unit for selecting a set of third coefficients based upon the speed of the speech and for analyzing said enhanced wave so as to determine a voice value based upon the third coefficients.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 diagrammatically illustrates a computer graphics system for communicating with an audience through a character which is controlled by an operator according to one preferred embodiment of the current invention.

FIG. 2 is a system diagram illustrating certain basic components of one preferred embodiment according to the current invention.

FIG. 3 further illustrates some detailed as well as additional components of another preferred embodiment of the computer graphics system according to the current invention.

FIG. 4 diagrammatically illustrates processes performed by an input voice processing unit according to the current invention.

FIGS. 5A, 5B, 5E and 5F illustrate the basic concept of the pitch shift process.

FIGS. 5C and 5D illustrate the basic concept of taking absolute values.

FIGS. 6A, 6B, 6C, 6D, 6E, 6F and 6G illustrate the result of combining the frequency shift waves according to the current invention.

FIGS. 7A and 7B diagrammatically illustrate processes performed by two embodiments for generating and combining the frequency shifted waves in a wave processing unit according to current invention.

FIG. 8 diagrammatically illustrates some aspects of the wave analysis according to the current invention.

FIG. 9 diagrammatically illustrates voice parameter generation processes performed by a voice parameter generation unit based upon the output from the wave analysis unit according to the current invention.

FIG. 10 is a flow chart describing processes performed after the voice parameter is generated so as to generate an animation parameter according to one preferred embodiment of the current invention.

FIG. 11 is a table illustrating exemplary coefficient values to be used in the current invention.

FIG. 12 is a table illustrating exemplary definitions for associating a set of lip patterns with a range of voice values and for a frequency for each of the lip patterns.

### DETAILED DESCRIPTION OF THE PREFERRED EMBODIMENTS

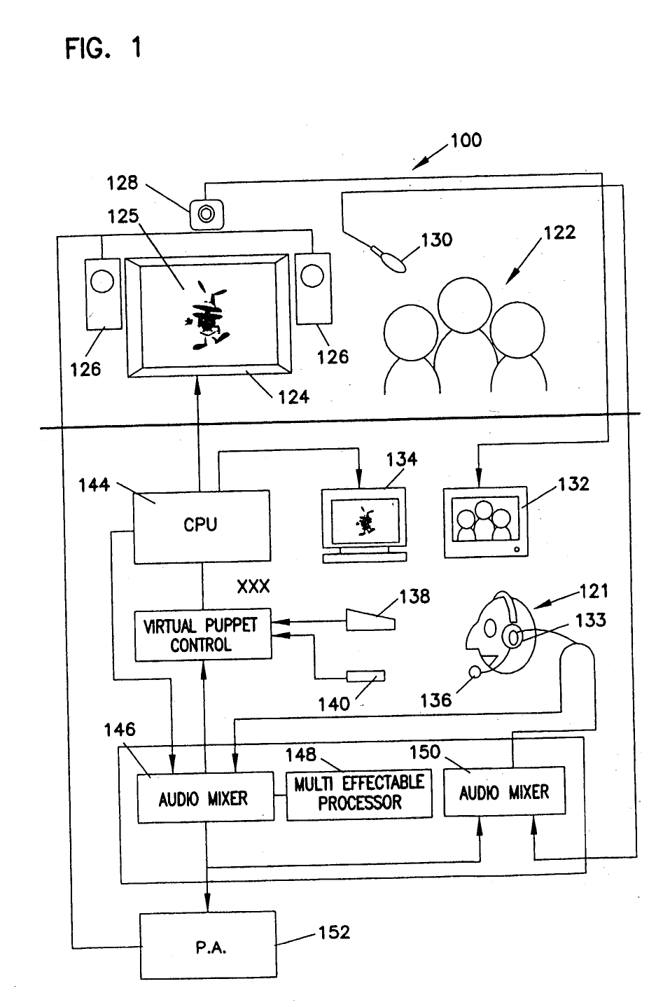

Referring now to the drawings, wherein like reference numerals designate corresponding structure throughout the views, and referring to FIG. 1, one preferred embodiment of the computer graphics animation system according to the current invention is diagrammatically illustrated. Although the system is used as a real-time presentation tool as well as an authoring tool, the real-time presentation system generally includes a presentation area 100 and a performance booth area 120. In the presentation area 100, a viewer or an audience 122 views an animation image 125 on a presentation display monitor 124 and listens to an audio output via a speaker 126. As the image character 125 is presented, the response of the audience is surveyed by an audience survey camera such as a CCD device 128 and a microphone 130. The surveyed visual and audio responses are sent to the performance booth 120.

The performer 121 generally speaks into a microphone 136. The voice input may be placed in an audio mixer 146 for modifying via a multi-effect processor 148 to be outputted to a public announcement system 152. In any case, the voice input is processed by a central processor 144 to determine a certain predetermine set of parameters for animating the character on the presentation display 124. In determining the animation, a controller 142 also polls additional input devices such as a control pad 138 and a foot switch 140. These input devices provides additional input signals for determining the animation sequence. For example, the additional input signals indicate expressions of the character such as anger, happiness and surprise. In addition, the additional input signals also indicate the orientation of the face with respect to the audience. The character 125 may be looking towards right with respect to the audience. Based upon the above-described input signals, the character 125 is animated in a lively manner.

Still referring to FIG. 1, the performer 121 is generally located in the performance booth 120, and the audience 122 is not usually aware of the presence. The performer 121 communicates with the audience 122 through the character 125. Although the audience cannot see the performer 121, the performer 121 can see and hear the audience through a monitor 132 and a head set 133 via an audio mixer 152 according to the above-described surveying devices. In this way, the performer 121 and the audience 122 interactively engage in a conversation. This interaction is not only spontaneous and natural, but also creative. The animation character is virtually anybody and anything including an animal, an object and a cartoon character.

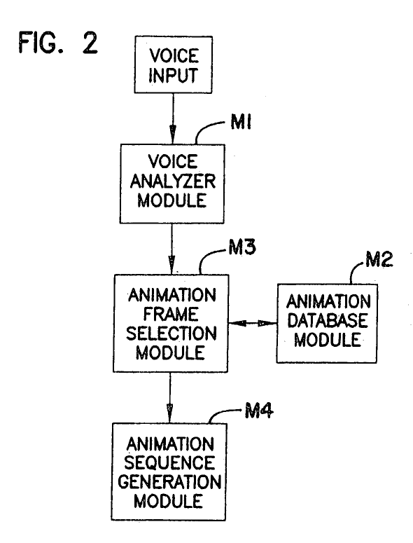

Now referring to FIG. 2, a block diagram illustrates one preferred embodiment of an animation system according to the current invention. A voice analyzer module M1 analyzes a voice input and generates a voice parameter. In response to the voice parameter, an animation frame selection module M3 selects appropriate animation frames from an animation database module M2. To generate a desired animation sequence, an animation sequence generation module M4 outputs the selected animation frames in a predetermined manner. According to this preferred embodiment, the animation database module M2 includes a predetermined number of animation frame sequences which are organized base upon the voice parameter.

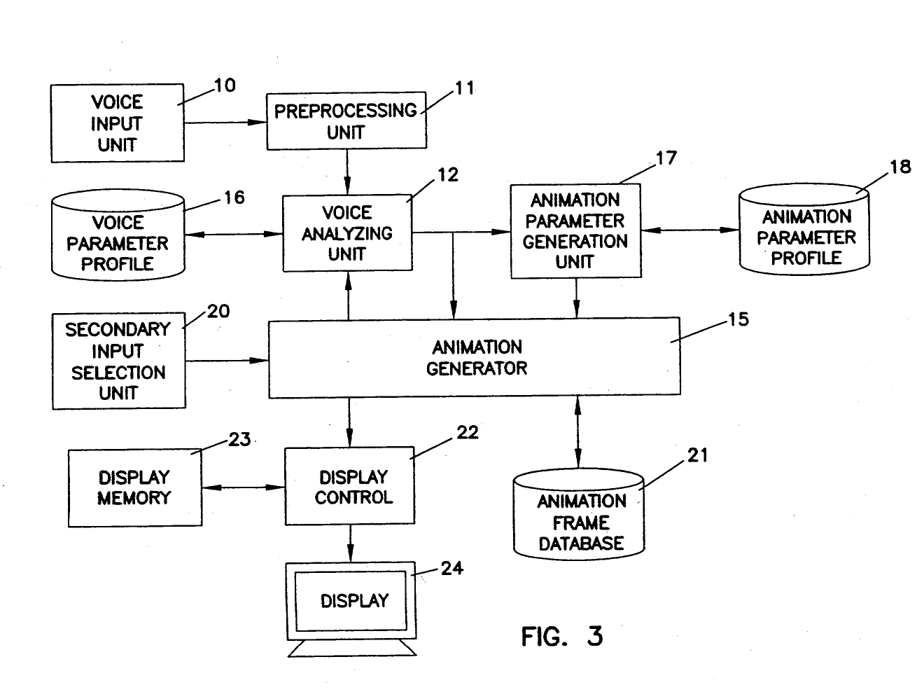

Referring to FIG. 3, a block diagram illustrates a second preferred embodiment of an animation system according to the current invention. A voice input is inputted into the system via a voice input unit 10 and is amplified or filtered by a preprocessing unit 11 before outputting to a voice analyzing unit 12. The voice analyzing unit 12 analyzes the voice input so as to determine a volume parameter, a volume change parameter, a pitch parameter and a pitch change parameter. Upon receiving a trigger signal from an animation generator 15, the voice analyzing unit 12 adjusts the values of a voice parameter set according to a voice parameter profile 16, which includes adjustment values for adjusting a predetermined characteristic of the voice input. For example, the voice parameter profile values correct a difference in frequency range between a female voice input and a male voice input. This is because female voice generally ranges from approximately 250 Hz to approximately 500 Hz while male voice generally ranges from approximately 200 Hz to 400 Hz, and the higher frequency range is more easily detected for a volume change.

Still referring to FIG. 3, the adjusted voice parameters are sent to an animation parameter generation unit 17. As similar to the voice parameter adjustment, the animation generation unit 17 also adjusts the animation parameter using an animation parameter profile 18 which includes character specific information. The adjusted animation parameter is outputted to the animation generator 15. The animation generator in turn polls a secondary input selection unit such as a key pad or a foot switch to collect additionally specified information for generating an animation sequence. As described above, the additional information includes expressions such as anger, happiness, surprise and other facial or bodily expressions. In addition, the secondary information also includes the orientation of the face of the character with respect to the viewing audience such as right, center or left. Upon receiving the adjusted animation parameters along with the secondary information, the animation generator 15 retrieves a desired sequence of animation frames from an animation frame database 21. Finally, the animation generator 15 outputs the animation frames to a display 24 via a display control 22 and a display memory 23.

According to a preferred embodiment according to the current invention, both the voice analyzing unit 12 and the animation generator 15 for polling the secondary input selection unit 20 are capable of sampling at approximately 60 times a second. However, the animation generator 15 retrieves an appropriate sequence of animation frames at a slower speed ranging from approximately eight frames to approximately 25 frames per second. Because of this limitation in displaying the animation sequence, in effect, the sampling devices are generally set at a common speed within the lower sampling speed range. In other words, since these sampling processes are performed in a predetermined sequence and each process must be complete before the next process, the slowest sampling process determines the common sampling speed and provides a certain level of machine independence.

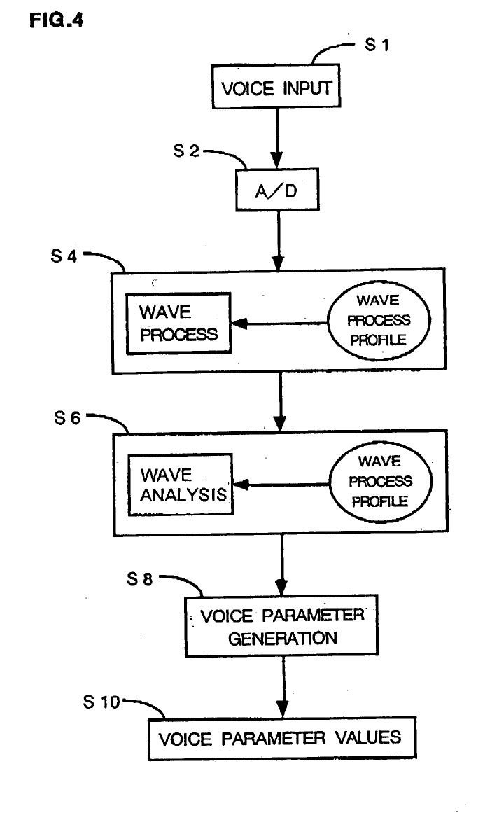

Now referring to FIG. 4, a flow chart describes general processes performed by the voice analyzing unit 12 of FIG. 3. In a step S1, the voice input is usually inputted in the animation system in an analog format via an analog device such as a microphone. The analog voice signal is converted into a digital format in an analog to digital conversion process in a step S2. The digitized voice signal is then preprocessed by a wave preprocess in a step S4. In the step S4, the waveprocess preprocesses the digitized voice signal based upon the characteristics of the voice input data or signal. The voice input characteristics include gender, pitch and speed of the input speech. The characteristics are selected from a wave process profile in which sets of characteristic data or coefficients are stored. Each of the characteristic profile data sets includes a pitch shift coefficient A, a pitch shift coefficient B, merging coefficients and process coefficients. The preprocessed digitized voice input is analyzed in a wave analysis process in a step S6 to determine intermediate parameter values. In step S6, the wave analysis also utilizes the characteristics of the voice input data or signal. The voice input characteristics include gender, pitch and speed of the input speech. The characteristics are selected from the wave process profile in which sets of characteristic data or coefficients are stored. Each of the characteristic sets includes a pitch shift coefficient A, a pitch shift coefficient B, merging coefficients and process coefficients. The intermediate values or parameters include a frequency change parameter, a frequency parameter, a volume parameter and a volume change parameter. Based upon the intermediate parameter values, a voice parameter generation process S8 generates voice parameter values. The voice parameter values are outputted in a step 10. Some of the above-described general processes will be described in some detail.

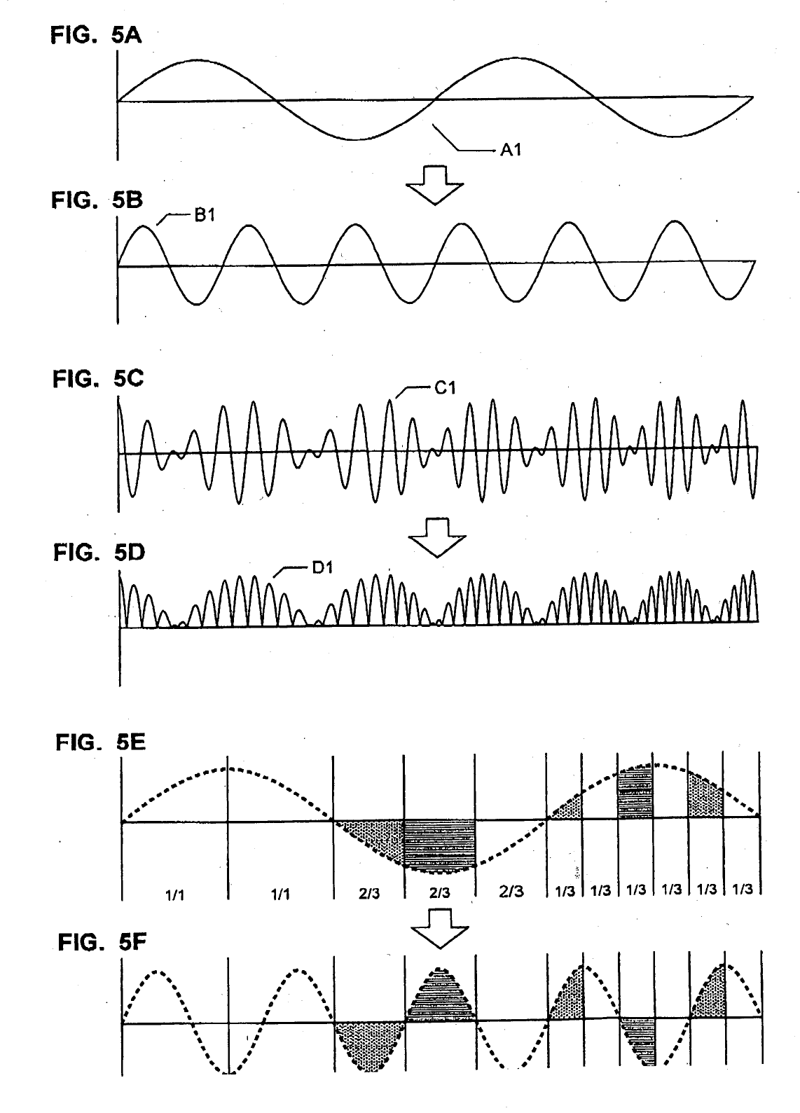

The preprocess step S4 includes a process similar to a pitch shift as shown in FIGS. 5A-5F. Although the voice input is already in a digitized data, the process similar to the pitch shift is performed on the digitized data. In general, the pitch shift is performed to modify the pitch characteristic or frequency component of the voice input without modifying the duration of a sampling time. As shown in FIGS. 5E and 5F, the pitch shift process compresses the voice input signal in the X axis by shifting by a predetermined factor such as 3. This increased frequency characteristics provides an improved voice signal to represent the changes in volume per a unit time. For example, within a two third of the original time unit, one half cycle of the pitch-shifted voice input signal is detected without fail. Similarly, within a one third of the original time unit, one quarter cycle of the pitch-shifted voice signal is detected without fail. In contrast, without pitch shifting within a two third of the original time unit, it is not certain what part of the one half cycle of the original input signal is detected. By the same token, without pitch shifting, it is also not certain what part of the one quarter cycle of the original input signal is detected. The above unpredictability suggests that an average value of the input signal varies if it is calculated by sampling at a predetermined time frequency without pitch shifting.

In particular, even though the original voice input has rapid changes in volume, the improved pitch shifted signal provides a smoother signal without jumping or bursts, yet responsive to the rapid changes. The increased frequency improves a response characteristics of the wave analysis step S6. In contrast, a merely shortened sample period generates an undesirable signal with bursts. The shortened sampling period does not necessarily respond to a fast raising input level. Furthermore, a response data from a short sampling period is also affected by phase changes in the original input data. As a result, the signal obtained by short sampling does not reflect the audio perception of the original input.

Original input data as shown in a graph A of FIG. 5 is pitch-shifted to a graph B. As a result of the above-described pitch shift process, the original input data is enhanced for certain response characteristics over a unit time. Because of the increased frequency response in data B1, input data from a short sampling period is not affected by the phase of the input data.

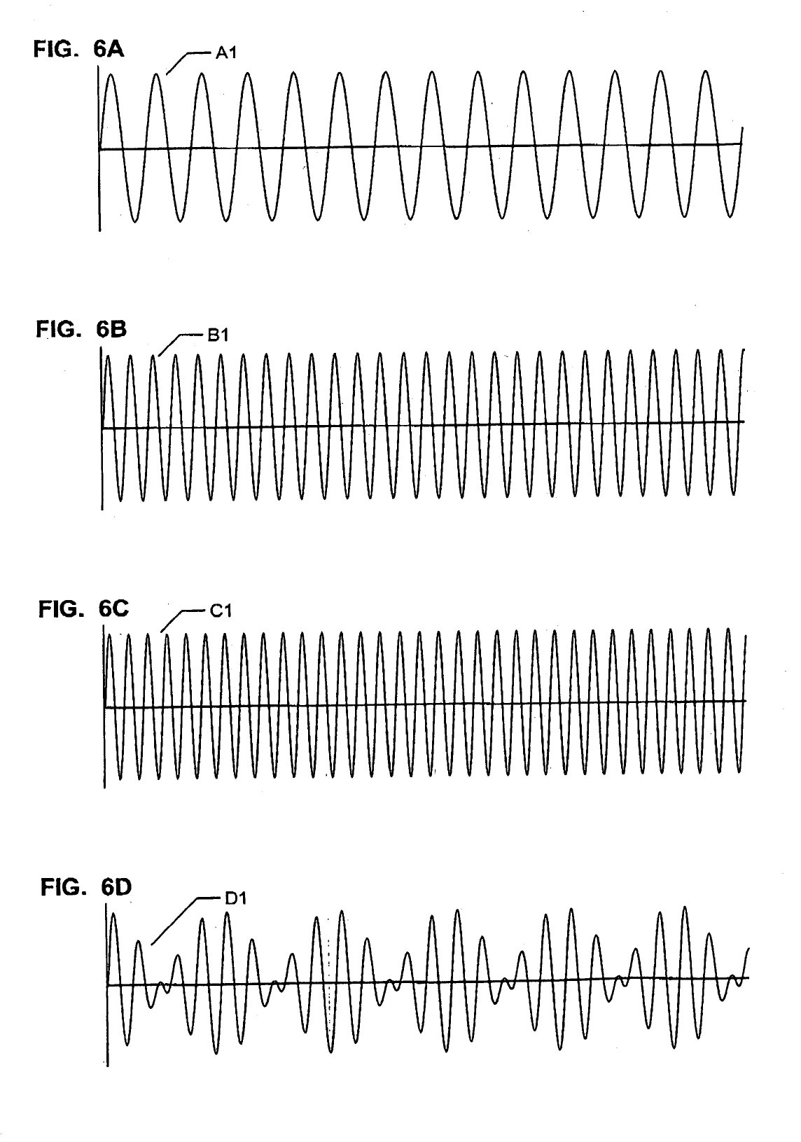

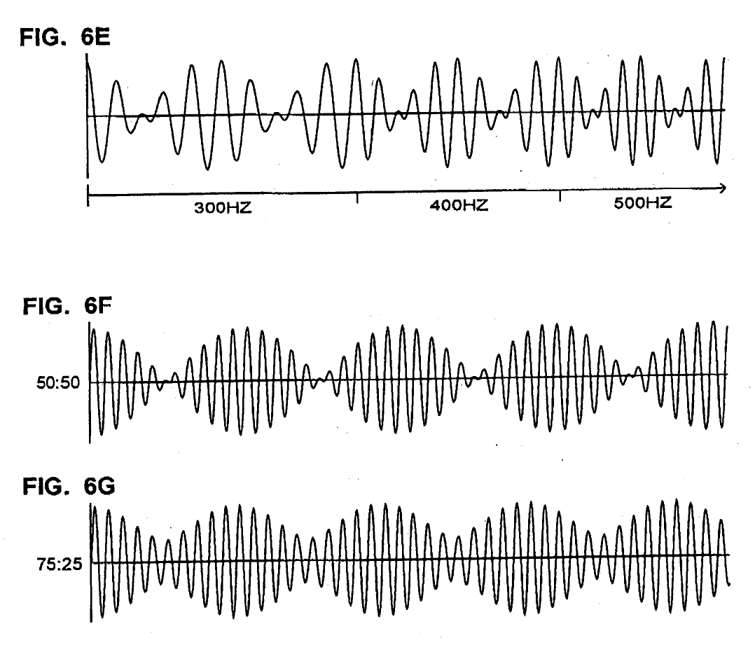

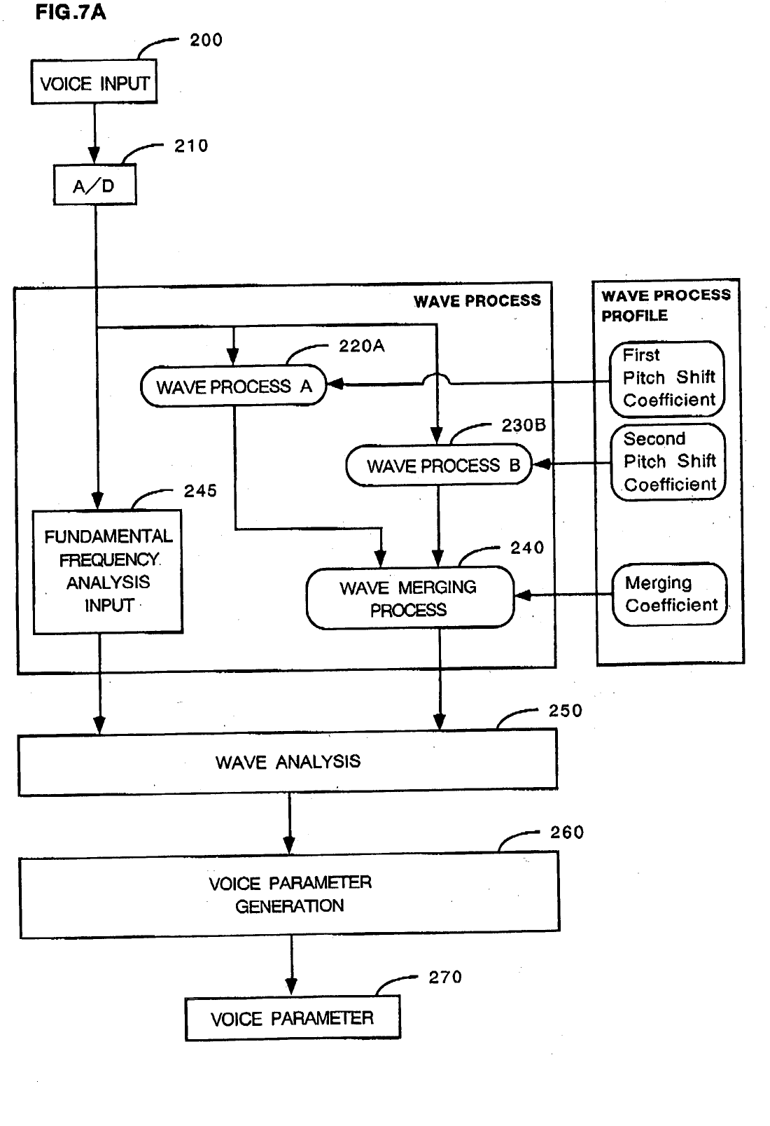

To effectively implement the pitch shift process, referring to FIGS. 6A through 6D, according to one preferred embodiment of the current invention, two pitch-shifted waves are generated from an original input data A1 as shown in FIG. 6A so as to combine them to generate an optimal input signal. FIGS. 6B and 6C respectively show a first pitch-shifted wave signal B1 and a second wave signal C1. For example, the second wave signal C1 is generated by further pitch-shifting the first wave signal B1 by one degree, and the first wave signal B1 is generated by pitch-shifting the original input A1 by one octave. As described above, the amount of pitch shifting is specified by the pitch shift coefficients A and B. The value of the pitch shift coefficients A and B is determined based upon the gender, the pitch and other speech characteristics of the speaker. A pair of the pitch shift coefficients A and B is defined to have a slight difference in value so that the pitch shifted signals have interference when they are added or merged together. The interference causes greater amplitude or level change in the merged signal. As shown in FIG. 6D, the two pitch-shifted wave signals B1 and C1 are combined into a single input signal D1. The combined input signal D1 has a component that reflects the second wave signal C1, and the component is generally considered as a small oscillation as a result of the addition and the subtraction of the two wave signals B1 and C1. The oscillation is used to generate a natural swaying motion of the lips or other body movements during speech by the animated character in accordance with the frequency changes of the input voice.

Referring to FIG. 6E, the above described interference effect depends upon frequency changes of the input voice. In response to the real voice input, since the frequency changes over time, the amplitude due to interference is not constant during merging. The amplitude changes as the frequency changes from 300 Hz to 500 Hz as shown in FIG. 6E.

Now referring to FIGS. 6F AND 6G, the above pitch-shifted signals are merged together according to a merging coefficient. The merging coefficient determines the influence of each of the two pitch-shifted signals towards the merged signal and ultimately the voice value of the parameters. In other words, the merging coefficient determines the amount of influence of the frequency change upon the voice value parameter. For example, FIG. 6F shows that the two pitch-shifted signals are merged together according to a 50:50 ratio while FIG. 6G shows that the same signals are merged according to a 75:25 ratio. The influence of frequency change on the voice value is related to the lip movement reaction of a character, and the voice value parameter thus adjusts the lip synchronization.

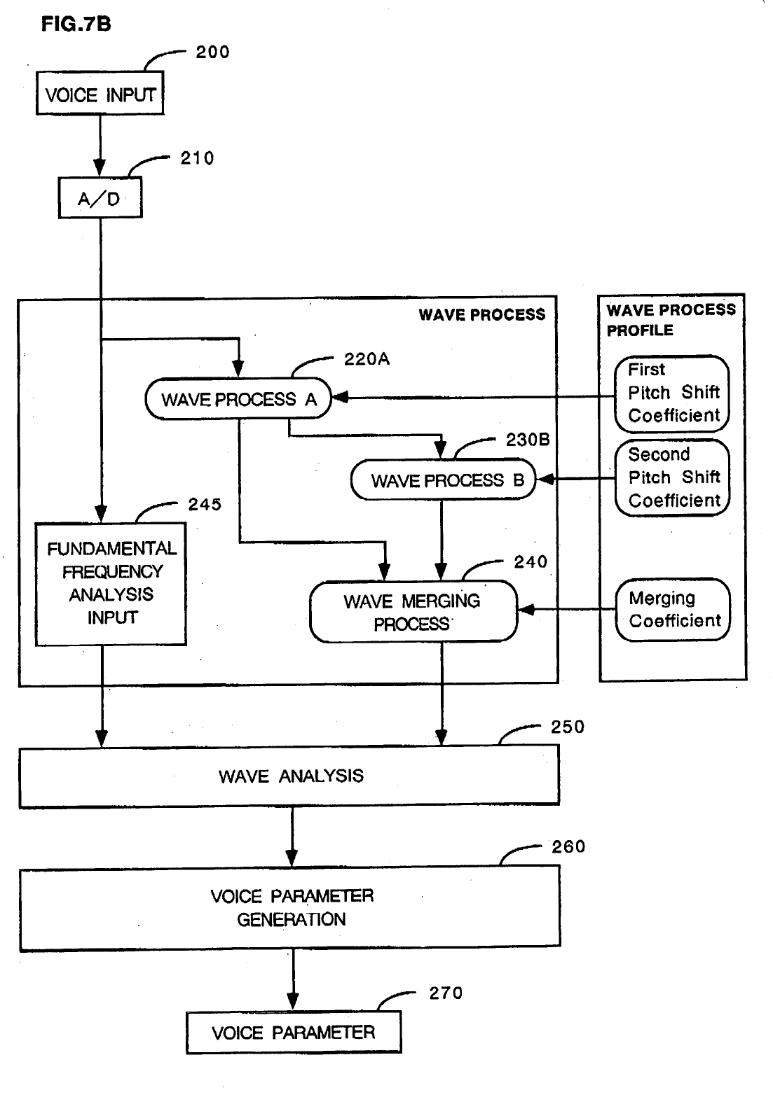

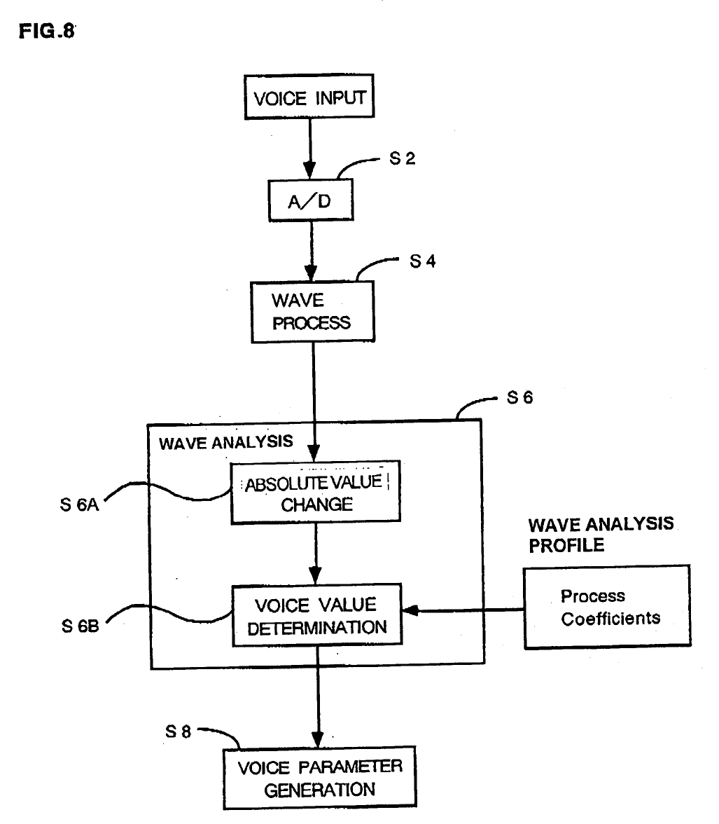

Now referring to FIG. 7A, according to one preferred embodiment of the above-described pitch shift process, a voice input signal 200 is converted into digital signals by an Analog-to-Digital converter 210. A digitally converted input voice signal is simultaneously pitch-shifted into two separate wave signals by Wave Processes 220 and 230. The Wave Process 220 A converts the digitally converted voice input signal 200 into the first wave signal based upon a selected one of first pitch shift coefficients A from a wave process profile. Similarly, the Wave Process 230 B converts the digitally converted voice input signal 200 into the second wave signal based upon a selected one of second pitch shift coefficients B from the wave process profile. The two pitch-shifted signals are combined into one wave signal by a wave merging process 240 based upon a selected one of the merging coefficients from the wave process profile. The combined wave signal along with the original input signal 245 is sent to a wave analysis process. The wave analysis process 250 generates a predetermined set of parameters 260. Upon receiving the generated parameters 260, a voice parameter generation process 270 generates a voice parameter.

Now referring to FIG. 7B, an alternative embodiment of the above-described pitch shift process generates the two wave signals from the digitally converted input signal in the following manner. Except for a first wave process A 220A and a second wave process B 230B, other processes are substantially identical to those as shown in FIG. 7A, and the descriptions are not repeated here. The second wave process B 230B generates a second signal by further pitch-shifting a first wave signal which is already pitch-shifted once from an input voice signal by a first wave process A 220A. The further pitch-shifting by the second wave process B 230 B is based upon a selected one of second pitch shift coefficients B. The first and second pitch-shifted signals are combined by the wave margin process 240 based upon a selected one of the merging coefficients from the wave process profile. The rest of the processes in FIG. 7B are substantially similar to those of FIG. 7A.

FIG. 8 illustrates some detail steps of the wave analysis process S6 as shown in FIG. 4 according to one preferred embodiment of the current invention. The wave analysis process S6 receives the above described merged pitch-shifted signal from the wave preprocess S4. In the wave analysis process S6, the merged pitch-shifted signal is further wave-analyzed according to a process coefficient value. The process coefficient values are stored in a wave analysis profile, and one of the process coefficients is selected based upon the predetermined characteristics of the input voice. The wave analysis process S6 includes a first step S6A of taking an absolute value of the merged pitch-shifted signal. The absolute value is generally taken by converting any negative portion into a corresponding positive portion. One example of the absolute value process is illustrated in FIGS. 5C and 5D, where the negative portions of the signal C1 in FIG. 5C are folded over across the X axis as shown in a signal D1 in FIG. 5D.

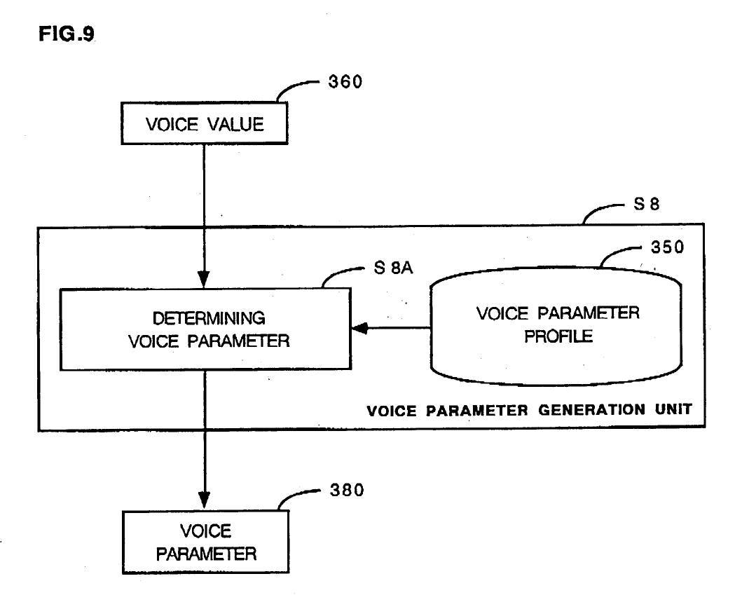

Still referring to FIG. 8, the wave analysis process S6 also further includes a voice value determination S6B. The voice value determination S6B generates a voice value 360 as shown in FIG. 9 which reflects the pitch and the like based upon the speed of speech in the input signal. The voice value 360 is generated by dividing the above absolute value wave signal by a unit time that is determined by the process coefficient. In other words, the process coefficient becomes larger as the speech is faster. As the process coefficient becomes larger, each divided signal portion becomes shorter or smaller. The divided wave signal and the X axis define an area that corresponds to the voice value 360. The above area determination method is the same as the light process of determining the volume. Although the short divided signal portion causes the voice value to change rapidly, the lip synchronization appears to be responsive. The process coefficient is made large when the lip synchronization is more important than fine nuance with-the movement.

Referring now to FIG. 9, the voice parameter generation process S8 of FIG. 8 includes further steps of adjusting the voice value from the wave analysis process S6 according to a voice parameter profile 350. The voice parameter profile 350 contains specific sets of coefficients for adjusting the voice value 360 in a step S8 based upon a certain predetermined characteristics of the input voice signal, such as the gender of the voice.

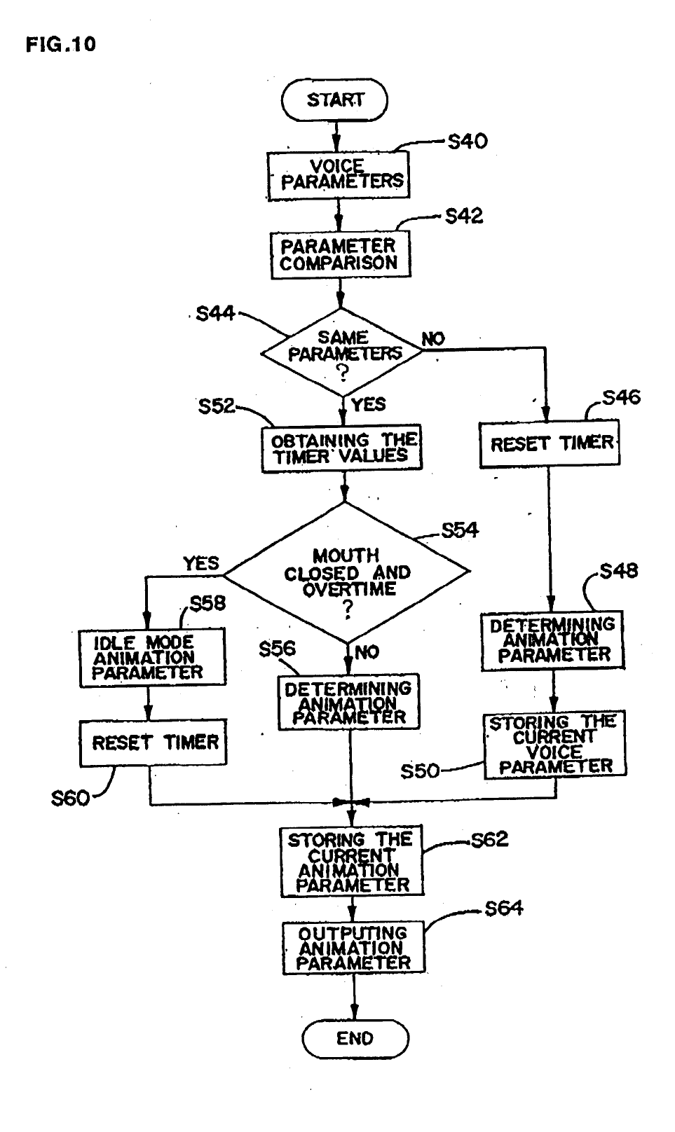

Referring to FIG. 10, after the above-described voice parameter is generated, according to one preferred embodiment of the current invention, the system generally generates an animation sequence for animating a character according to the voice input from a step S40. To realistically animate the character, in steps S42 and S44, the currently generated voice parameter is compared to the last stored voice parameter so as to determine a context sensitive factor for the animation. In other words, for example, if the mouth is already open as indicated in the last voice parameter and the current voice parameter indicates no input voice. The next animation sequence frames should include the closing movements for the mouth.

Still referring to FIG. 10, when the step S44 determines that the current and last voice parameters are the same, the amount of the time in the same state is obtained from a timer in a step 44. As described later, the timer is reset to keep track of time in a particular state each time the current parameter indicates a new state. In a step S54, the current voice parameter is examined with respect to the mouth opening position and the above obtained timer value. In other words, it is determined whether or not the current voice parameter indicates a close mouth status and whether or not the timer value is larger than a predetermined value. If both of the two conditions are met, in a step 58, the animation parameter is determined based upon the above-described conditions. Under these conditions, the animation parameter generally indicates a predetermined idle mode. The idle mode will be fully described later with respect to the absence of the input voice. In the following step 60, the timer is reset. On the other hand, if both conditions are not met, in a step 56, the animation parameter is specified to reflect these failed conditions.

In the above step 44, when the current and the last voice parameters fail to match, an animation sequence is determined to reflect a change in the character representation. In a step S46, the timer is reset so that an amount of time in the new state is monitored. In a step S48, based upon the current voice parameter, a new animation parameter is determined. In a step 48, the current voice parameter is stored since the current voice parameter is different from the last. In any event, the new or current animation parameter is stored for the next comparison in a step S62.

The current animation parameter generally specifies an animation sequence of the animation frames for animating the character in accordance with the voice parameter. In a step 64, the new animation parameter is outputted to an animation generating/rendering system.

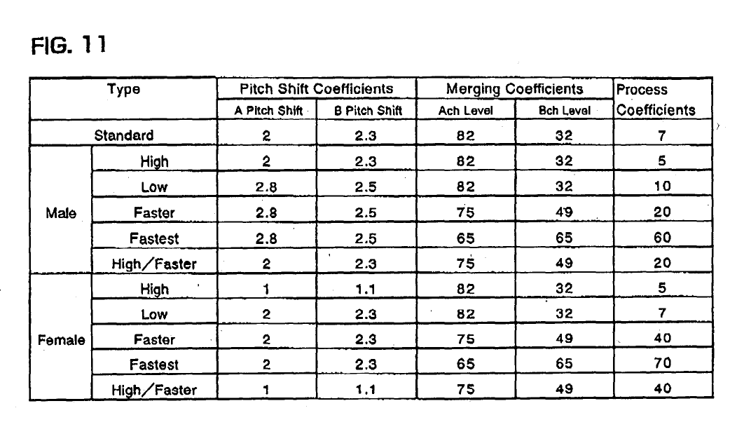

Referring to FIG. 11, a table illustrates exemplary coefficient values to be used in the above described preferred embodiment according to the current invention. The table contains the pitch shift coefficients A and B, merging coefficients and process coefficients. Each of the coefficients has a particular exemplary value depending upon a set of predetermined characteristics of the input voice data. For example, for the input voice data that is spoken by a female with a high pitch, the pitch shift coefficients A and B respectively have a value of 1 and 1.1. For the same input voice data, the merging coefficient or ratio is 82:32 for the two pitch shifted signals while the corresponding process coefficient is 5. The above exemplary characteristics includes gender, pitch, speed of the input speech.

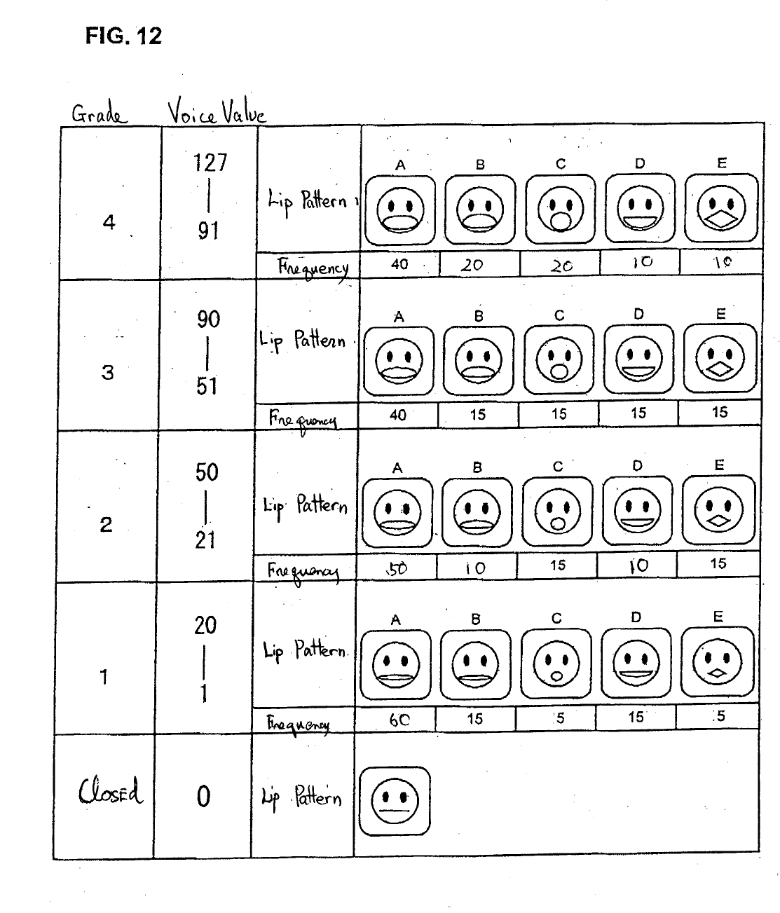

FIG. 12 is a table illustrating exemplary definitions for the voice parameter profile 350 as shown in FIG. 9 for associating a set of lip patterns with a range of voice values and for a frequency for each of the lip patterns. For each animation character, a range of certain voice values is associated with a predetermined grade. The voice value ranges from 0 to 127 while the grade ranges from closed to the fourth level. For example, for the fourth grade, the voice value ranges from 91 to 127. The above definitions are uniquely established for each of the animation characters. For each lip pattern in a set of the lip patterns, a frequency is predetermined, and the frequency determines a relative appearance of the particular lip pattern among other lip patterns in the set. The above described voice parameter include some of the above definitions such as the grade and the lip pattern including frequency.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method of analyzing a digitized voice input, comprising the steps of:
a) digitizing speech into digitize voice input;
b) generating a plurality of waves based upon the digitized voice;
c) selecting a set of first coefficients based upon a pitch level of the speech;
d) pitch shifting the waves according to a corresponding one of the selected first coefficients; and
e) selecting a set of second coefficients based upon a speed of the speech; and
f) adding said pitch shifted waves based upon the second coefficients so as to generate a merged wave.

2. The method of analyzing the digitized voice input according to claim 1 wherein the first coefficients and the second coefficients are stored in a wave process profile, the first coefficients being pitch shift coefficients, the second coefficients being merging coefficients.

3. The method of analyzing the digitized voice input according to claim 2 further comprising additional steps of:
g) selecting a set of third coefficients based upon the speed of the speech;
h) analyzing said merged wave by taking absolute value;
i) determining predetermined voice value based upon the third coefficient; and
j) generating a voice parameter based upon the voice value, said voice parameter indicating an increased sensitivity level for detecting a change in at least the pitch and the speed of the speech

4. The method of analyzing the digitized voice input according to claim 3 wherein the third coefficients are stored in a wave analysis process profile, the third coefficients being process coefficients.

5. The method of analyzing the digitized voice input according to claim 4 wherein the first coefficients, the second coefficients and the third coefficients are determined based upon the gender of a speaker who inputs the voice input.

6. An input voice analyzing apparatus for analyzing a digitized voice input, for speech comprising:
a wave processing unit for selecting a set of first coefficients based upon a pitch of the speech and generating a plurality of pitch shifted waves based upon the first coefficients, said wave processing unit selecting a set of second coefficients based upon a speed of the speech and adding said pitch shifted waves based upon the second coefficients so as to generate an enhanced wave; and
a wave analysis unit connected to said wave processing unit for selecting a set of third coefficients based upon the speed of the speech and for analyzing said enhanced wave so as to determine a voice value based upon the third coefficients.

7. The input voice analyzing apparatus according to claim 6 further comprising:
a voice parameter generation unit connected to said wave analysis unit for generating a voice parameter set based upon said voice value, said voice parameter set indicating an increased sensitivity level for detecting a change in at least the pitch and the speed of the speech.

8. The input voice analyzing apparatus according to claim 6 wherein the first coefficients and the second coefficients are stored in a wave process profile, the first coefficients being pitch shift coefficients, the second coefficients being merging coefficients.

9. The input voice analyzing apparatus according to claim 8 wherein the third coefficients are stored in a wave analysis process profile, the third coefficients being process coefficients.

10. The input voice analyzing apparatus according to claim 9 wherein the first coefficients, the second coefficients and the third coefficients are determined based upon the gender of a speaker who inputs the voice input.
